(19) United States
(12) Patent Application Publication
(10) Pub. No.: US 2007/0278221 A1
(43) Pub. Date: Dec. 6, 2007

(54) Method and apparatus for cooking foods

(76) Inventor: William A. Skaife, San Marco, CA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/800,473

(22) Filed: May 4, 2007

Related U.S. Application Data
(60) Provisional application No. 60/797,965, filed on May 5, 2006.

(51) Int. Cl. H05B 6/80

(52) U.S. Cl. 219/730

(57) ABSTRACT

The present invention is a microwavable pressure cooking container assembly and method using a flexible film vessel capable of holding a quantity of liquid and a food. A sealing device is at an upper portion of the vessel for sealing the vessel. An aperture is formed in an upper portion of the vessel which restricts release of steam from the vessel, so as to cause an increase in pressure and heat within the vessel to a level of pressure and heat which does not adversely affect the flexible film vessel, yet increases speed of cooking the food.

### CROSS-REFERENCE TO RELATED APPLICATIONS

This application claims priority under 35 U.S.C. §119 to provisional application Ser. No. 60/797,965 filed May 5, 2006, herein incorporated by reference in its entirety.

The following related and commonly owned patents are incorporated herein by reference in their entirety: U.S. patent application Ser. No. 10/269,455 filed Oct. 11, 2002, now issued U.S. Pat. No. 7,172,780 and U.S. patent application Ser. No. 10/955,186 filed Sep. 30, 2004.

### BACKGROUND OF THE INVENTION

This invention relates to microwavable cooking. Specifically, this invention relates to an improved method and apparatus for cooking foods.

It has become known that foods generally do not cook as well in a microwave as they do in an oven or on a stovetop. Therefore, microwaves are generally only used for warming up foods and not for cooking meals.

It is known that traditional pressure cookers heat up on a stovetop and create steam and pressure within the pressure cooker to decrease the cooking time of the food cooked within the pressure cooker and produce gourmet results in flavor and texture retaining the nutrition. However, pressure cookers are bulky, need maintenance, and have fallen out of favor with modern cooking trends.

In light of the foregoing, there is a need in the art for an improved quick pressure cooking device incorporating the attributes of both the pressure cooker and the microwave oven.

Thus, the primary feature or advantage of the present invention is an improved method and apparatus for cooking foods.

One or more of these and/or other features or advantages of the present invention will be apparent from the specification and claims that follow.

### BRIEF SUMMARY OF THE INVENTION

One or more of the foregoing features or advantages may be achieved by a microwavable pressure cooking container assembly constructed from a flexible film vessel which is capable of holding a quantity of liquid and food. A sealing device is at an upper portion of the vessel for sealing the vessel. An aperture is placed in an upper portion of the vessel. The aperture restricts the release of steam from the vessel, so as to create an increase in pressure and heat within the vessel to a level of pressure and heat which does not adversely affect the flexible film vessel, yet increases the speed of cooking the food.

A further aspect of the present invention involves the flexible film vessel having a gusseted bottom.

A further aspect of the present invention is a microwavable pressure cooking container assembly constructed from a flexible film made from retort plastic film.

A further aspect of the present invention involves a microwavable pressure cooking container assembly having a zipper closing device for sealing the container.

A further aspect of the present invention involves a microwavable pressure cooking container formed as a pie shaped device to allow multiple vessels to stand beside one another on a circular tray.

A further aspect of the present invention involves a microwavable pressure cooking container having tabs attached for ease of holding the vessel, reduce heat exposure to the hands of the person holding the vessel and to assist in opening and closing a sealing device on the vessel.

A further aspect of the present invention involves a microwavable pressure cooking container which holds one or more removable steam resistant trays for separating food and positioning the food at different levels within the container.

A further aspect of the present invention involves a microwavable pressure cooking container which has an aperture that seals itself when there is low pressure inside the vessel and the aperture vents excess pressure to outside the vessel when the pressure inside the vessel reaches a threshold pressure.

One or more of the foregoing features or advantages may additionally be achieved by a method of cooking food in a microwave by placing the food in a microwavable pressure cooking container, the container capable of restricting release of steam to maintain a desired pressure inside the container, adding liquid inside the container, sealing portion of the container, placing the container in a microwave oven, setting a time for cooking the food, and starting the microwave oven, thereby allowing steam to build up in the container and vent from the container at the desired pressure.

A further aspect of the present invention involves a method of cooking food in a microwave where the food can be cooled in the cooking container and stored for later re-heating of the food in the container.

A further aspect of the present invention involves a method of cooking food in a microwave by adding spices to flavor the food.

### BRIEF DESCRIPTION OF THE DRAWINGS

FIG. 1 is a photograph of one embodiment of the microwavable pressure cooking container assembly of the present invention.

FIG. 2 is a photograph of the cooking container assembly of FIG. 1 shown opened.

FIG. 3 is the cooking container assembly of FIG. 1 as viewed from the top.

FIG. 4 is the pressure cooking container assembly of FIG. 1 viewed from the bottom.

FIG. 5 is one embodiment of a tray system for separating foods within the cooking container assembly of FIG. 1.

FIG. 6 is a photograph of another embodiment of the present invention showing a steam release valve, a holding tray for holding the cooking container assembly inside of a microwave oven.

FIG. 7 is a photograph of multiple embodiments of the present invention.

FIG. 8 is a photograph of another embodiment of the present invention shown in a glass tray in a microwave.

FIG. 9 is a close-up of the pressure valve and zipper seal of the embodiment shown in FIG. 8.

FIG. 10 is a side view of one embodiment of the present invention using a pie shaped base.

FIG. 11 shows two pressure cooking container assemblies nested together as two of three pie shaped pieces on a microwave tray.

FIG. 12 is a photograph showing pressure cooking container assemblies of the present invention nested together within a microwave.

FIG. 13 shows another embodiment of the present invention having a zipper seal, a tab for opening and closing the zipper seal, a pie shaped bottom and a pressure release valve.

FIG. 14 is the embodiment of the present invention shown in FIG. 13 with the zipper seal at the top opened.

FIG. 15 is another embodiment of a pressure cooking container assembly of the present invention.

FIG. 16 is a cut-away view of the pressure release valve releasing steam and pressure from the pressure cooking container assembly as shown in FIG. 13.

FIG. 17 is yet another embodiment of the present invention showing a gusseted bottom, an openable top and an aperture pressure release valve.

FIG. 18 is yet another embodiment of the present invention with a semi-rigid bottom portion.

FIG. 19 is a close up of a portion of FIG. 18.

FIG. 20 is another embodiment of the pressure cooking container assembly of the present invention shown with a pie shaped bottom portion and a tab for aid of opening and closing a zipper seal.

FIG. 21 shows one embodiment of a pressure release valve for the present invention.

FIG. 22 shows the pressure release valve of FIG. 21 with a flap lifted up to allow insertion of liquids and spices into the pressure cooking container assembly.

FIG. 23 shows removal of excess tabs from the pressure release valve.

FIG. 24 shows insertion of liquids into the pressure cooking container assembly.

FIG. 25 shows the closing of the pressure release valve once liquids have been added to the pressure cooking container assembly.

FIG. 26 shows the pressure cooking container assembly filled with food and liquid and the valve closed and ready for cooking.

FIG. 27 shows one embodiment of the pressure cooking container assembly with food and the valve releasing steam and pressure.

FIG. 28 shows a sectional view of the valve shown in FIG. 21.

FIG. 29 is a photograph of the valve configured to look like a traditional pressure cooker.

FIG. 30 is another photograph of the valve configured to look like a traditional pressure cooker.

FIG. 31 is an exemplary software/recipes for the pressure cooking container assembly of the present invention.

FIG. 32 is a photograph of another embodiment of the microwave holding tray for the pressure cooking container assembly of the present invention.

FIG. 33 is a photograph of the holding tray shown in FIG. 32 with one embodiment of the tray system of the present invention.

FIG. 34 is a photograph of the holding tray shown in FIG. 32 with several pressure cooking container assemblies of the present invention.

### DETAILED DESCRIPTION OF THE PREFERRED EMBODIMENT

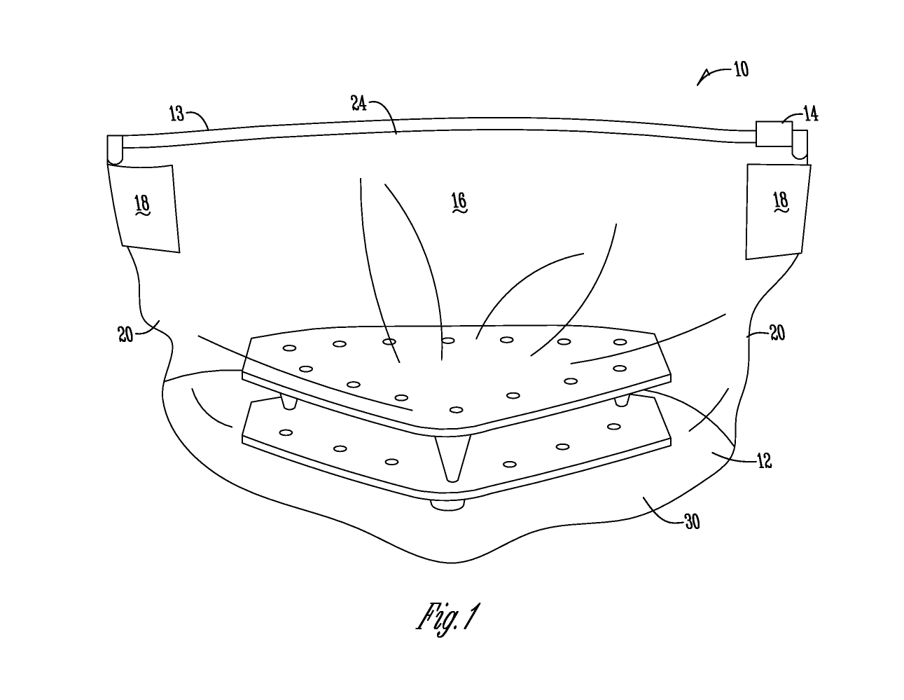

FIGS. 1-5 show the preferred embodiment of the microwavable pressure cooking container assembly 10 of the present invention. A flexible film vessel 12 is preferably constructed from retort plastic film. However, other types of food grade materials capable of withstanding developed pressures are acceptable. The vessel 12 has a zipper type sealing device 14 attached at a top portion 16 of the vessel 12. The zipper type sealing device 14 slides back and forth across a top portion 16 of the vessel 12 and either opens the vessel 12 or closes the vessel 12 (zipper 14 is in the closed position 24 as shown in FIG. 1). The zipper 14 should also be constructed from a food grade material and capable of withstanding the pressures developed within the cooking container assembly 10. Any appropriate way of attaching the zipper 14 to the film vessel 12 is acceptable.

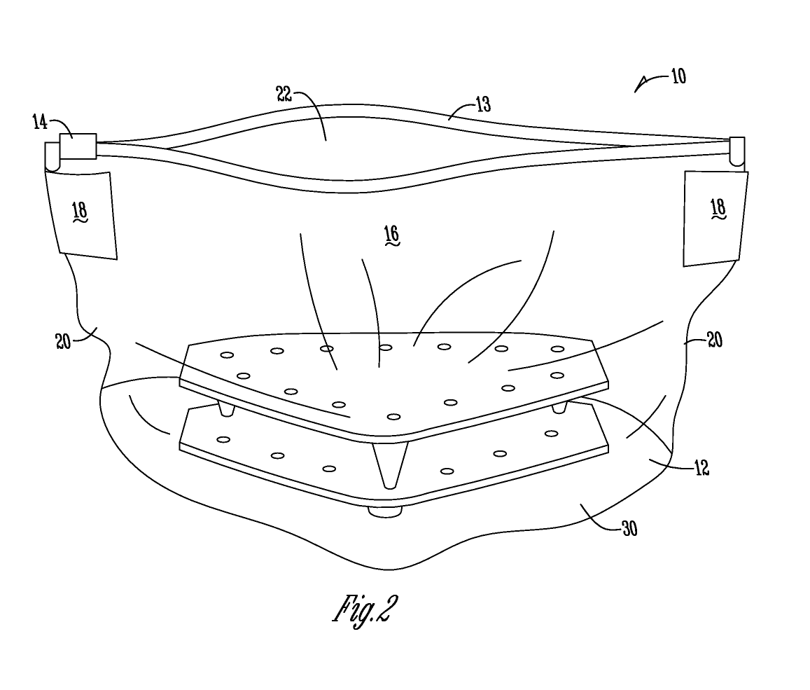

On each side 20 of the zipper 14 at a top portion 16 of the flexible film vessel 12 are tabs 18. The tabs 18 are made of heat resistant material which allows the user to hold the tabs 18 to lift or carry the pressure cooking container assembly 10 without getting burned. In addition, the user can hold the tab 18 on a side 20 which has the zipper device 14 for ease of holding the film vessel 12 while moving or sliding the zipper device 14. In addition, the tabs 18 allow the user to push inward on each side 20 and open the top portion 16 of the cooking container assembly 10 when the zipper 13 is in an open position 22 as shown in FIGS. 2 and 3.

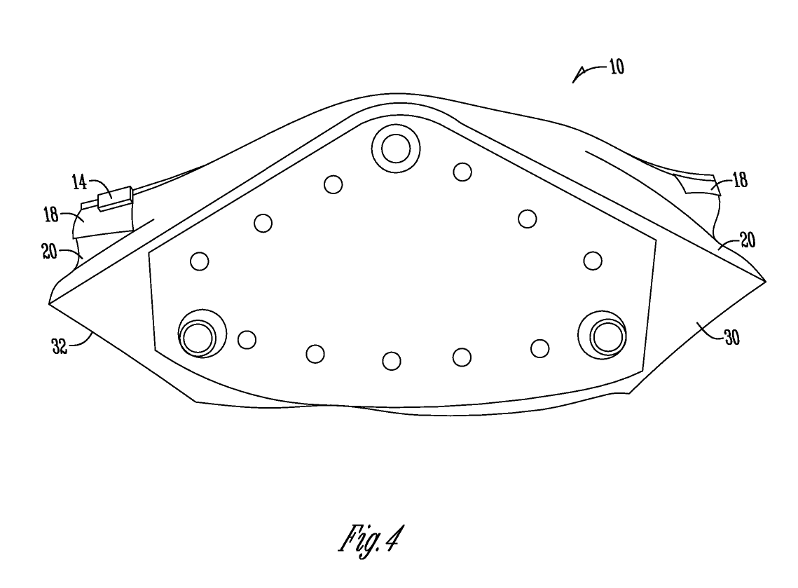

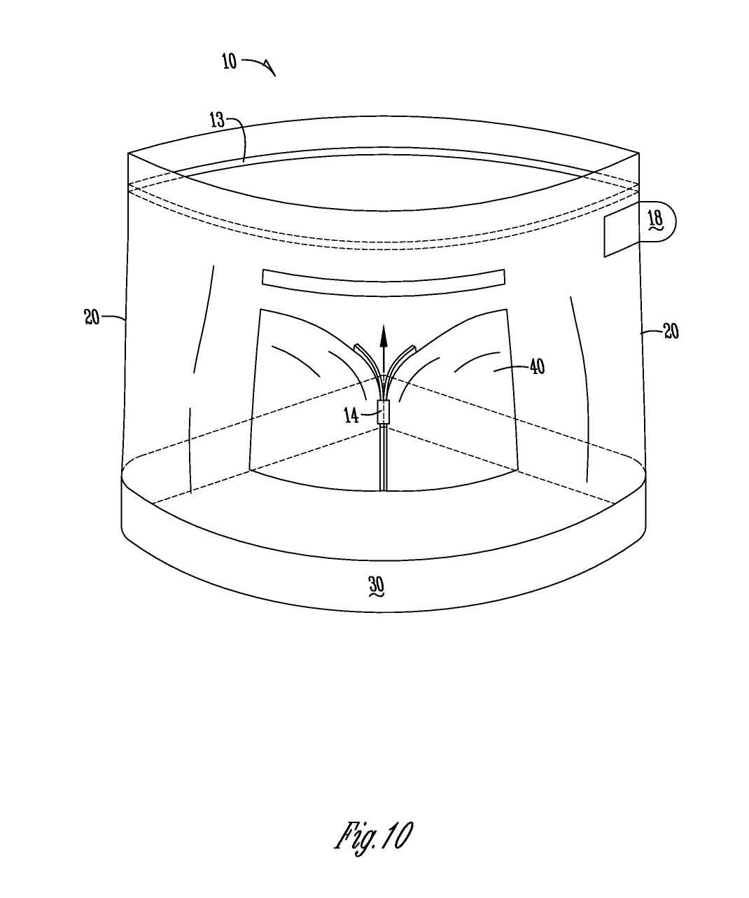

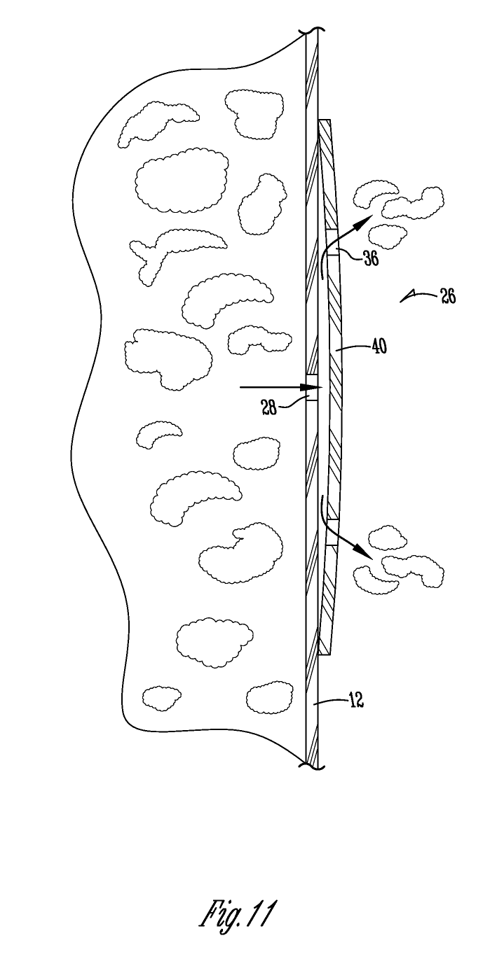

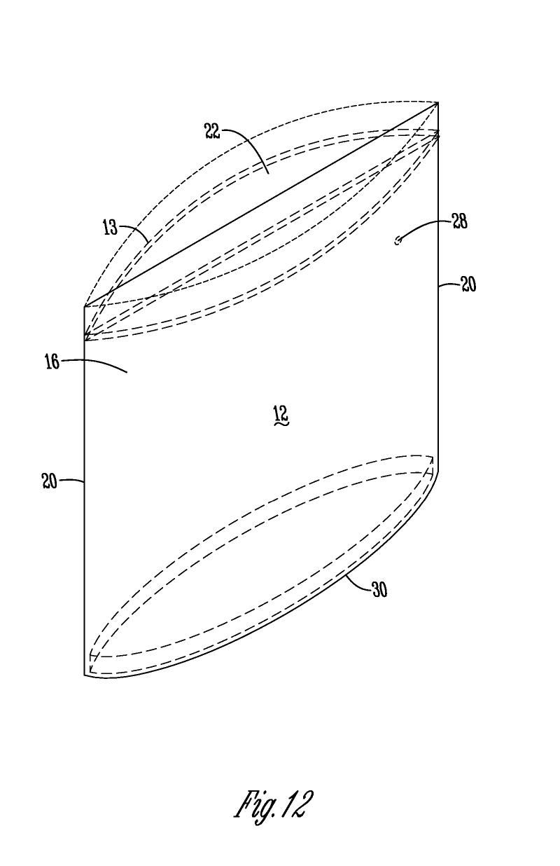

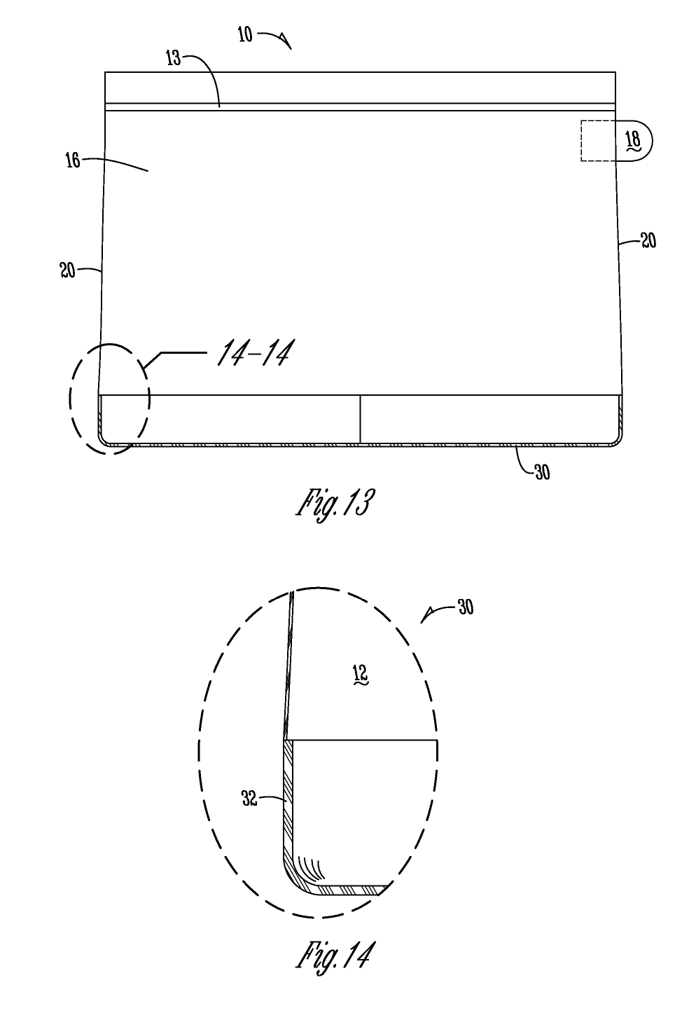

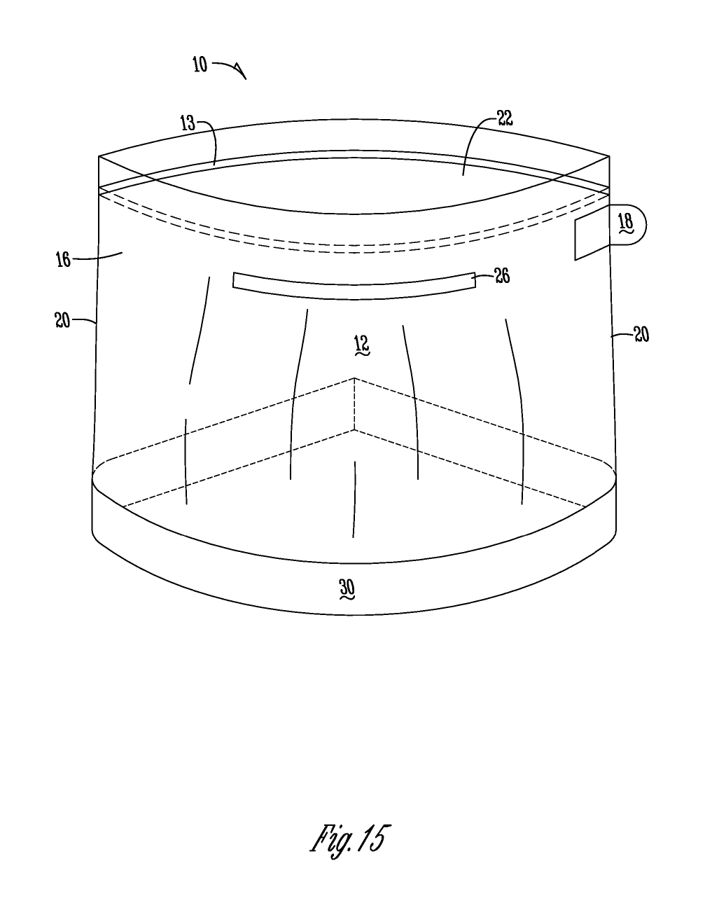

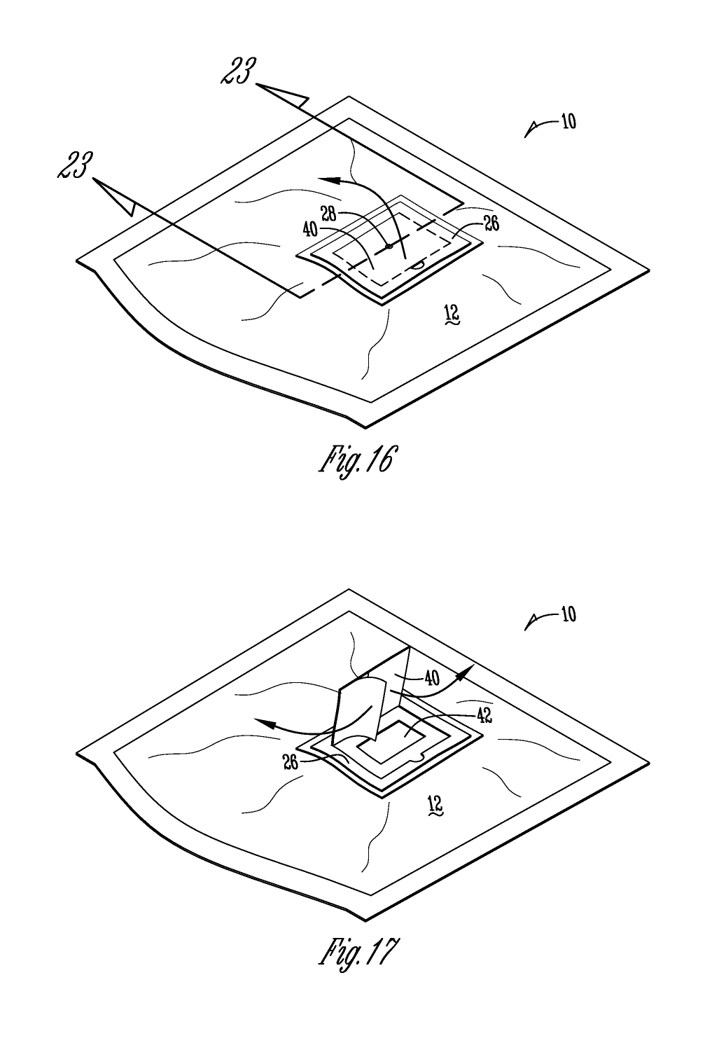

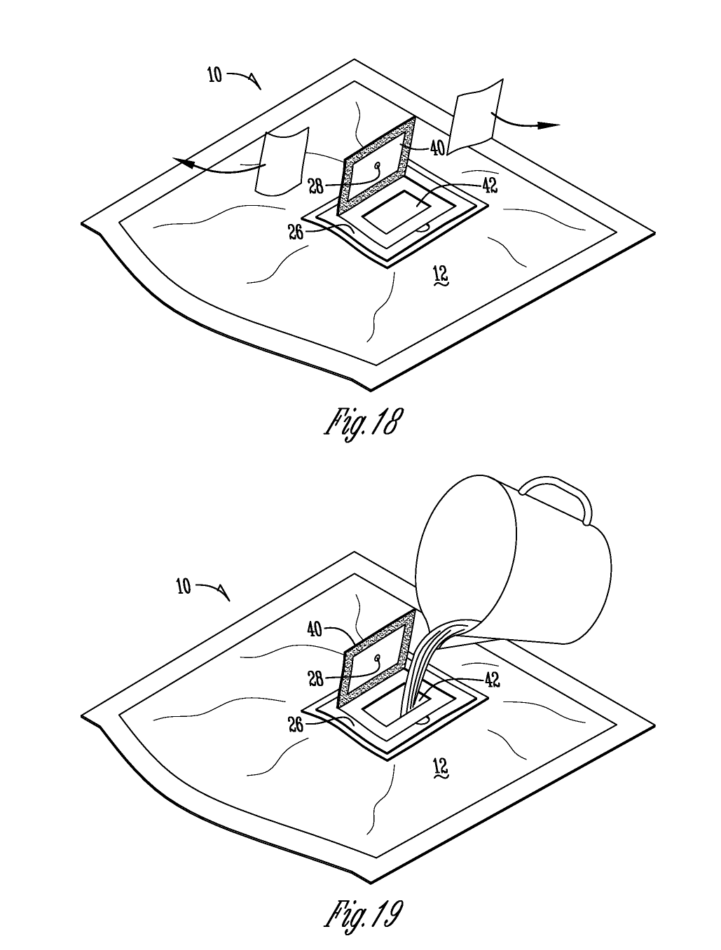

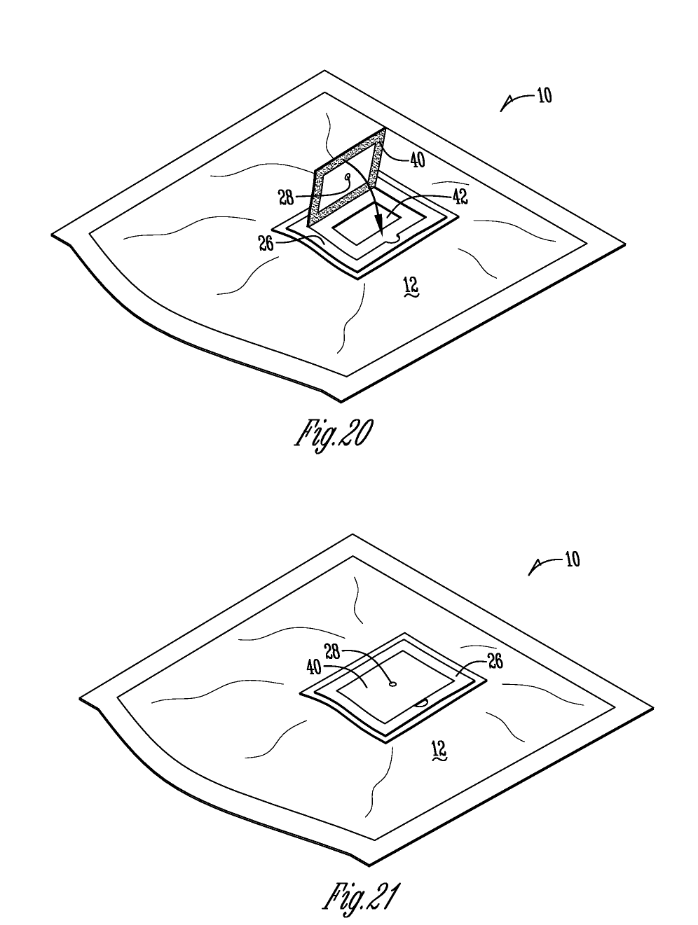

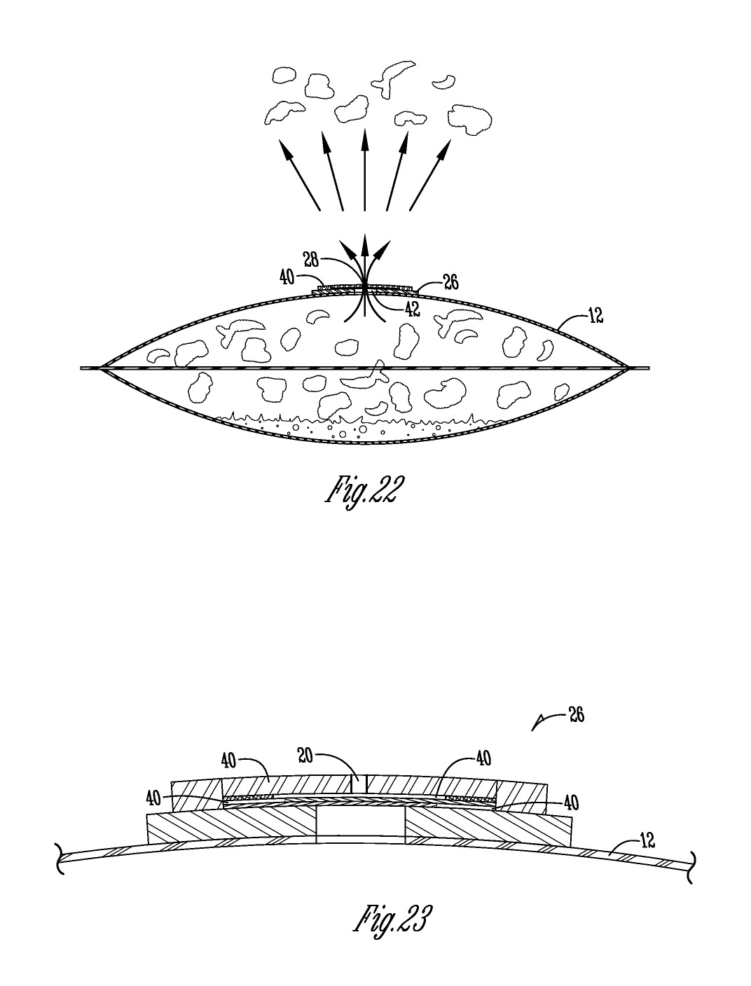

A pressure release valve 26 similar to the ones shown in FIGS. 6, 13, 14, 16, 17, 21-28 can be incorporated into the flexible film vessel 12 shown in FIGS. 1-4. Additionally, other types of venting apertures or valves can be used with the present invention so long as they are capable of being used with food products, can withstand the heat and pressure developed during cooking foods and are capable of being sized to maintain a pressure and quantity of steam inside the film vessel 12. The preferred opening size for the aperture 28 depends upon how much steam pressure is desired inside the cooking container assembly 10. In addition, the aperture 23 can be sized differently to adjust for altitude variations.

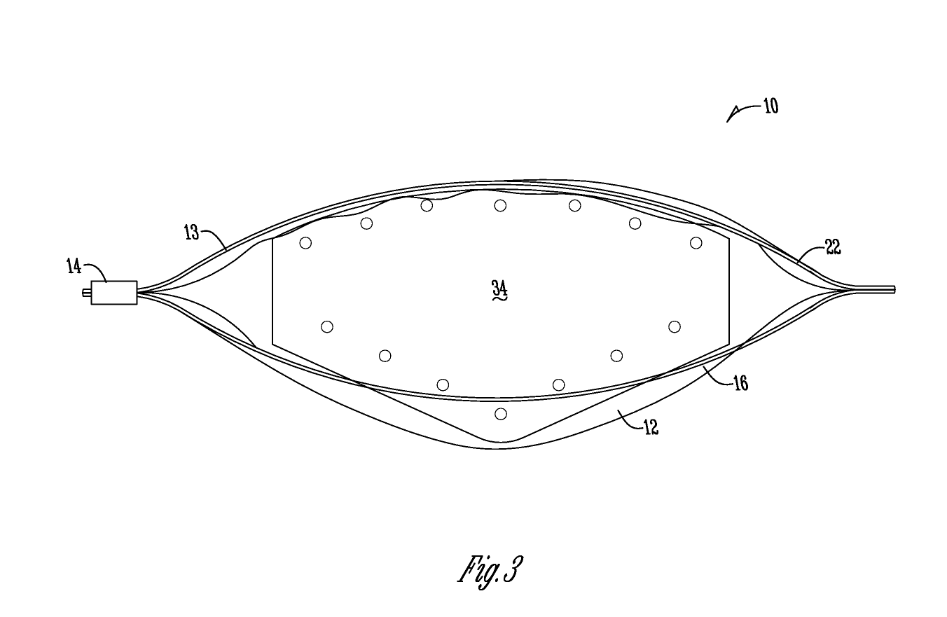

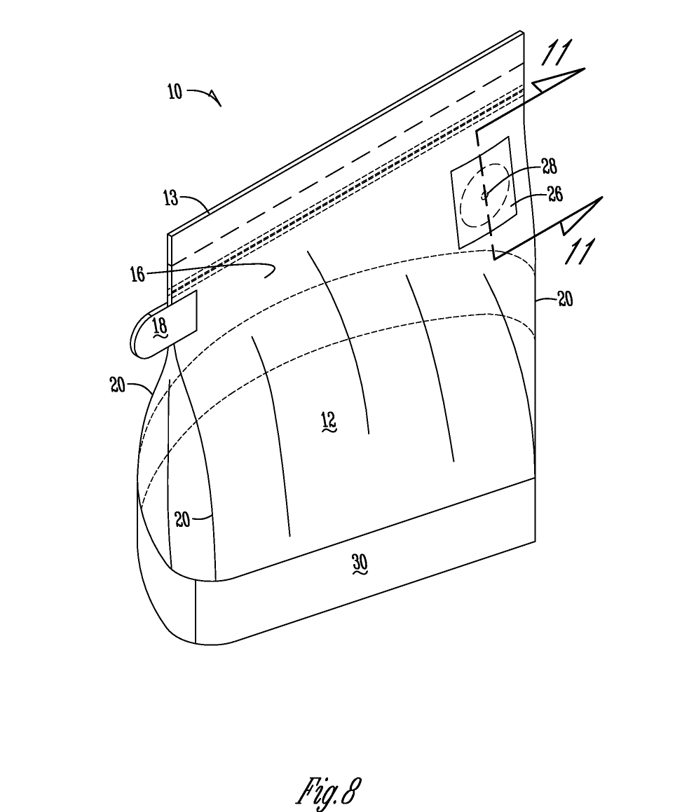

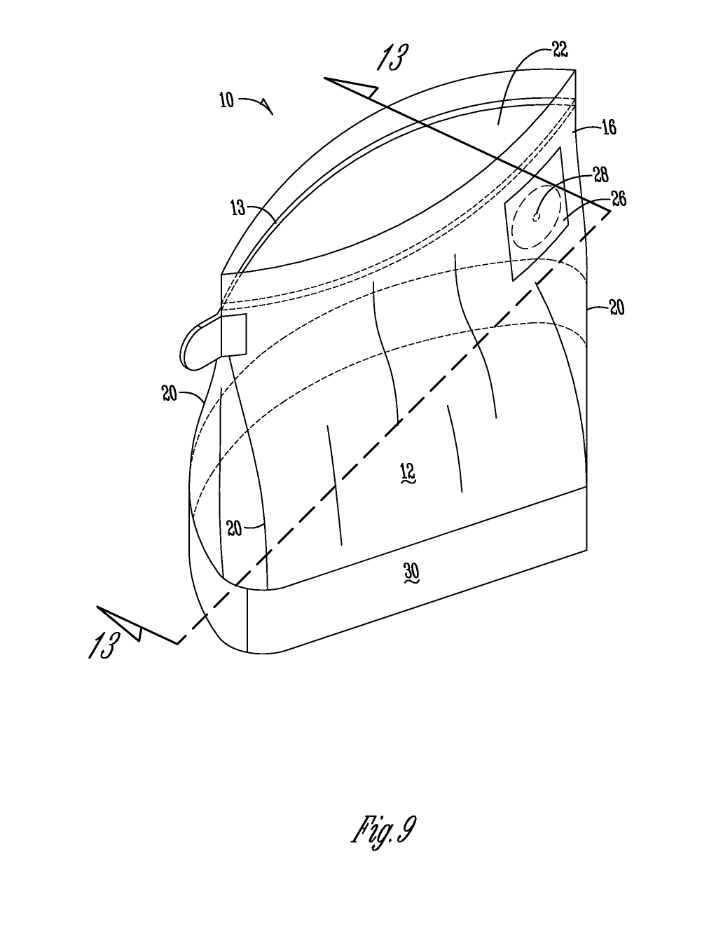

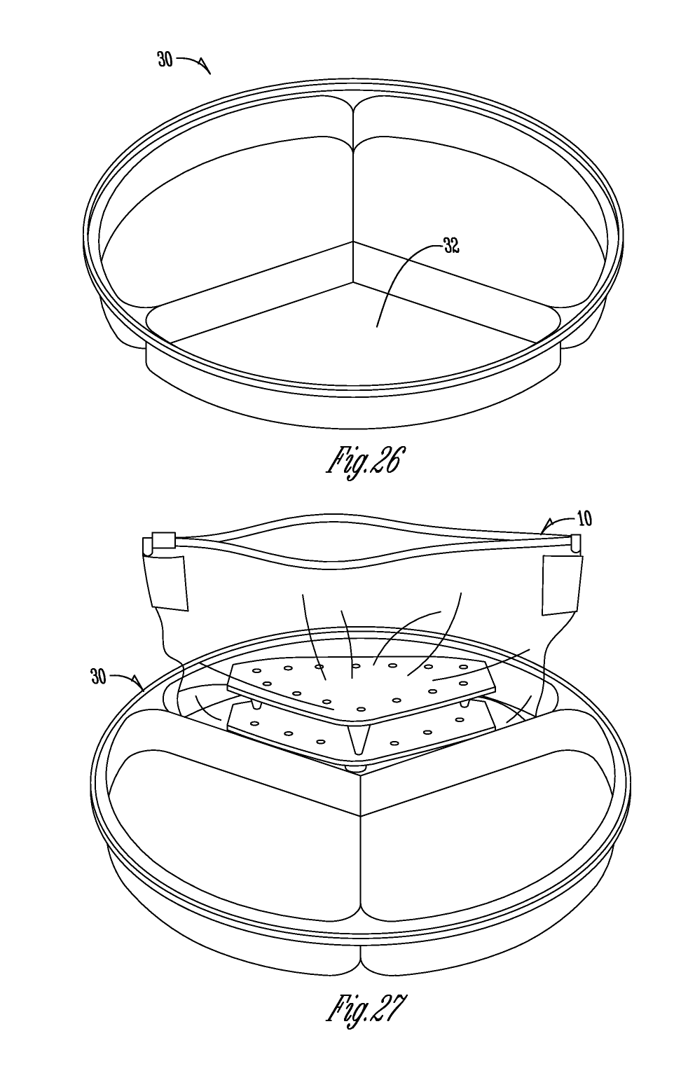

FIG. 4 shows a bottom portion 30 of the pressure cooking container assembly 10 having seals or gussets 32 formed into the film vessel 12 to shape the bottom portion 30 of the cooking container assembly 10 into a pie shape. This allows multiple pressure cooking container assemblies 10 to set adjacent one another on a single or multiple trays within a microwave (as shown in FIGS. 11-12 and 32-34) and cook simultaneously. The gussets or seals 32 in the bottom portion 30 of the flexible film vessel 12 can be formed into the film 12 by a heat sealing method. In addition, other methods can be used for forming a bottom portion 30 of the flexible film vessel 12 into a pie shape.

FIG. 5 shows a pair of trays 34 which fit into the pressure cooking container assembly 10 and allows for food to be stacked on the trays 34 at different levels so as to allow foods to maintain their original flavor. For example, potatoes can be cooked on one level, meat can be cooked on another level, and another vegetable can be cooked on still a third level. Thus, during the cooking process the foods can maintain their separate flavor plus certain foods are best if cooked with steam and not on the lower level in the boiling water inside the pressure cooking container assembly 10. The trays 34 shown in FIG. 5 are preferred to be made from a heat resistant and steam resistant material. In addition, holes 36 are preferred to be in the trays 34 to allow steam to pass freely between the layers inside the pressure cooking container assembly 10. Furthermore, the trays 34 are preferred to have legs 38 to help separate the trays 34.

The pressure cooking container assembly 10 is preferably made in the shape of pouch which is large enough to facilitate the cooking and storing of bulky, large volume items such as sweet corn, green beans, soups, etc. However, as mentioned above, multiple container assemblies such as three, may be simultaneously cooked in the microwave oven. As a result, the preferred embodiment of the pressure cooking container assembly 10 is used as a stand-up device.

The plastic retort film used in making the flexible film vessel 12 should of a material which can withstand extended, high-temperature microwave cooking. This retort film is preferred to be of a laminated-type film, however a single layer of sufficient strength can be used. Retort films have been used by food packers to package pre-cooked food so that a user can re-heat the food in the retort film. However, this is reheating the food and not cooking from scratch. In addition, the prior art retort bags do not have pressure apertures for containing pressure within the bag during a cooking process.

Using a stand-up flexible film vessel 12 allows for maximum containment of food up to the height inside of the microwave oven. The pressure release valve or aperture 28 is positioned near the top 16 of the flexible film vessel 12, well above the water level in the system so water does not leak out, even if the system is cooking soup.

A slider zipper 14 is preferred to be used for sealing the pressure cooking container assembly 10. It would be impractical to use a finger/thumb sealing opening zipper strip because the container assembly contains hot food and steam. The slider zipper 14 is preferred for keeping the heat away from the user and reducing burns. Using the tabs 18, shown in FIG. 1, the slider zipper 14 may be opened just a small amount to release the steam/heat gradually. However, using a finger/thumb zipper would allow an uncontrolled burst of heat out of the cooking container assembly at one time.

Different colored tabs 18 can be used on each side 20 of the zipper 13 so that as one is held and the slider zipper 14 is slid, the user is opening the vessel 12 and as the other color is held and the slider zipper 14 is slid, the user is closing the vessel 12. For instance, red could be used when opening the vessel 12, symbolizing caution or heat. Blue or green can be located opposite the red, symbolizing safe or cool.

Using the slider zipper 14 allows the user to use the pressure cooking container assembly 10 as a serving dish on the table and close the cooking container assembly 10 like a covered serving bowl. This helps to keep the food warm during a meal. The tab handles enable a family at a dining room table to conveniently pass the pressure cooking container assembly from person-to-person using the tab handles.

Another important benefit of the slider zipper 14 is the capability of the cook to judge the food as to the desired level of being done. Until the cook has determined the exact time to accurately complete the cooking for each food cooked, of a specific weight and configuration, the cook may remove the pressure cooking container assembly 10 from the microwave oven, easily open it using the slider zipper 14, test the food as to being done. If the food is not done, the user may reclose the cooking container assembly 10 and return it to the microwave oven for additional cooking. The cook may additionally easily and conveniently test the food as the cooking progresses, so as not to overcook the food. In addition, this allows the cook to remove foods at different cook levels or trays 34 such as rare, medium, or well done pieces of meat.

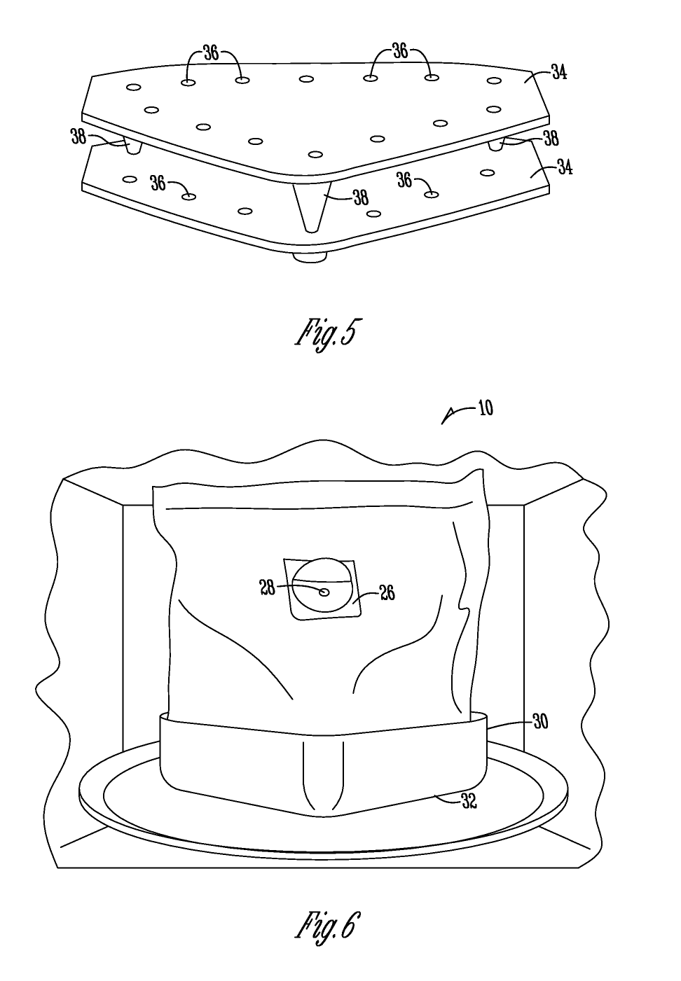

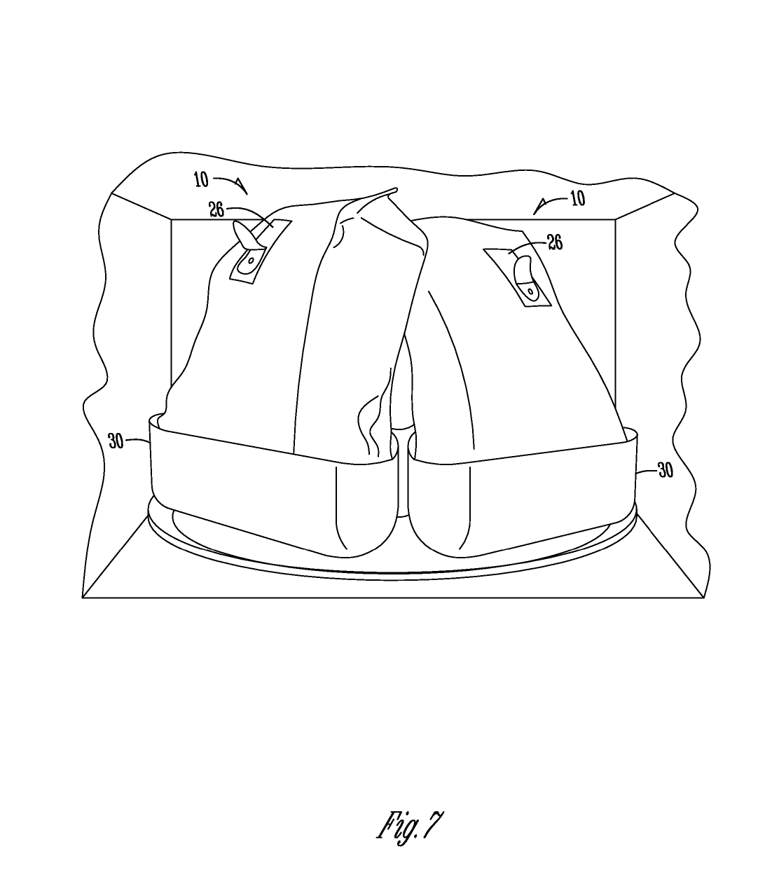

The bottom portion 30 of the flexible film vessel 12 is gusseted 32, as mentioned above and shown in FIGS. 6-7 and 10- 12. On prior art gusseted bags, the width at the bottom is generally minimized in relationship to the height of the bag. This is because the narrow width allows maximum utilization of shelf space in displaying the greatest number of product bags in a grocery store. The present invention has a broad gusseted 32 base 30 designed for maximum stability, rather than narrow. The stability of the pressure cooking container assembly 10 is because the container 10 will contain boiling liquid and hot food standing upright on a rotating glass plate in a microwave oven.

The slidable zipper 14 of the present invention allows the pressure cooking container assembly 10 to be reused to re-heat leftovers. The slider zipper 14, the vertical pouch design, and the tab handles 18 are more convenient and safer to use than traditional glass or plastic bowls.

The tab handles 18 shown in FIG. 1 can be pushed toward one another creating an oval shape and an opening at the top portion 16 of the pressure cooking container assembly 10. The zipper 13 preferably has a memory characteristic which allows the oval shape in the top portion 16 to remain so that the cooking container assembly 10 stays open for adding or removing products from the container 10 without having to hold the container 10 open.

The pressure containment/relief valve 26 or aperture 28 of the present invention is different from what is taught by current food packaging companies for releasing steam from a package. Current microwavable foods teach to release unregulated a maximum amount of pressure or steam from the container. In other words, the current practice is to poke holes in the container, trim off an edge of the container, or etc. so that all steam produced during the cooking process is released from the container. In addition, glass and plastic microwavable vessels also release all of the steam built up during cooking in a microwave.

On the other hand, the aperture 28 or steam relief valve 26 is designed to retain up to the maximum amount of pressure in the pressure cooking container assembly 10 that the flexible film vessel 12 is capable of containing. The higher the pressure, the higher the heat, the faster the food cooks. Another benefit of a regulated retention of steam pressure is that accuracy in cooking can be standardized with a regulated retention of steam or pressure within the cooking container assembly 10. On the other hand, punching fork holes, pealing back film, or even the use of porous film does not provide for the retention of a precise amount of steam or pressure within the cooking container assembly 10. Similarly, lifting a corner of a lid on a plastic or glass microwavable container does not allow the build up of pressure for faster cooking.

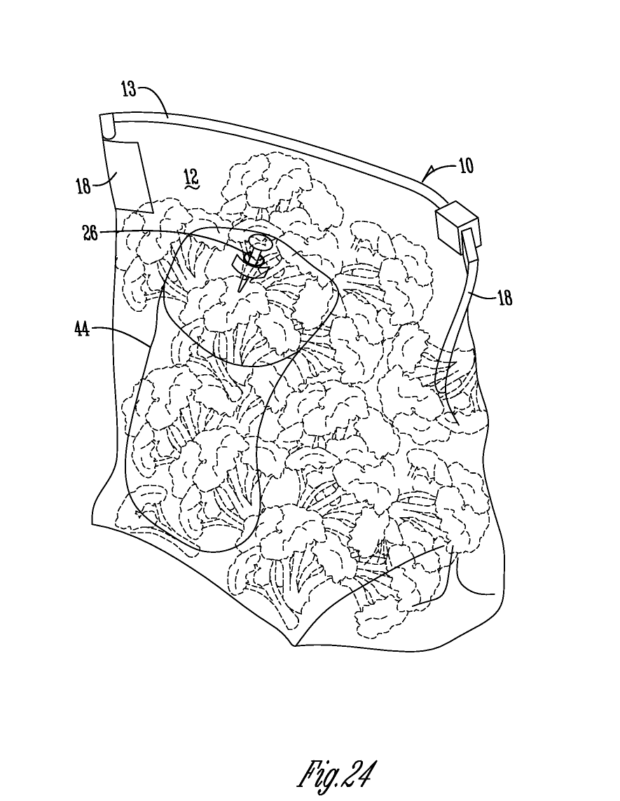

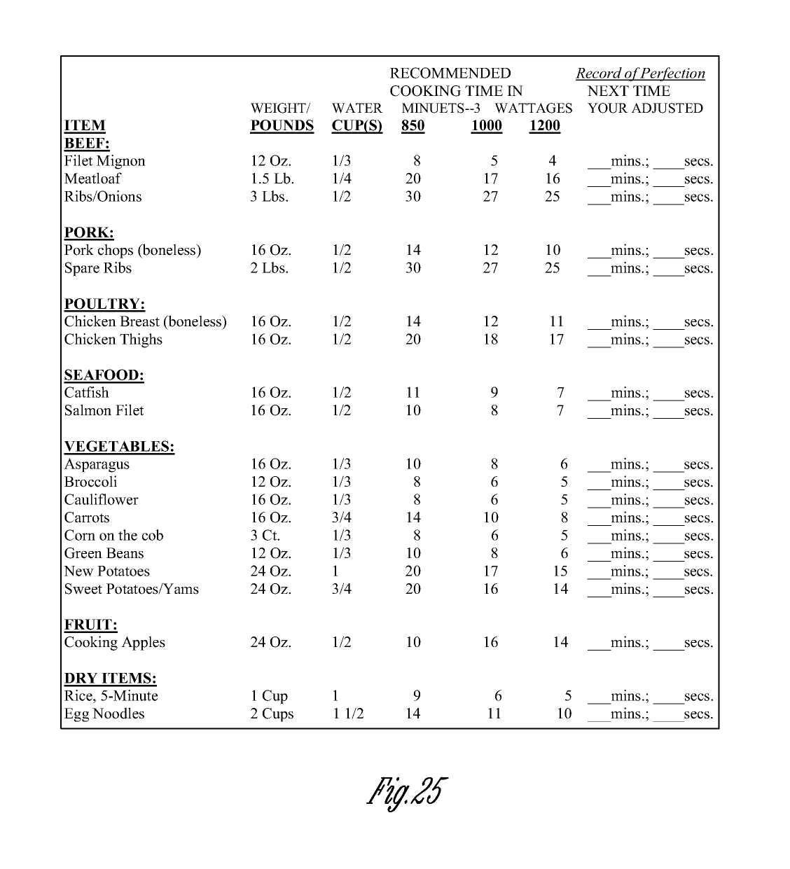

The steam relief valve 26 may be configured to look like a traditional pressure cooker (shown in FIGS. 29-30). This will allow users to associate the pressure cooking container assembly 10 of the present invention with the operation of traditional pressure cookers. The image of a traditional steam regulating bobber on traditional pressure cookers 44 can be incorporated as the pressure release valve 26 or aperture 28 in the present invention (shown in FIGS. 29-30). The bobber label 40 has a hole or aperture 28 in the flexible film vessel 12, which is offset and hidden under the valve/label 40 similar to the valve shown in FIGS. 13, 14 and 16. This makes the system capable of containing pre-packaged foods and tamper proof on supermarket shelves, while at the same time allowing steam to automatically escape to holes 42 in the label 40 as pressure is built up between the label 40 and the flexible film thereby opening up the aperture 28 in the flexible film vessel 12 and holes 42 in the label 40 offset from the apertures 28 in the flexible film vessel 12. Recipes or cooking details can be printed on a side of the pressure cooking container assembly 10 for use by the person cooking (shown in FIG. 31). Additionally, a recipe book can be included with the purchase of pressure cooking container assemblies 10.

In conventional cooking and using the microwave oven, there is not a direct relationship between cooking time and density/weight. It has been found, however, that there is significantly less relationship of cooking time to weight/density using the microwave oven than traditional cooking. For example, three separate foods, can be cooked simultaneously to completion in the cooking time which is only slightly longer than the time required to cook the food item requiring the longest cooking time rather than the sum of times for cooking each food individually (shown in FIG. 34). This capability of the microwave oven results in speed and convenience for the cooker. A benefit is that this principle requires less energy.

Microwave ovens are notorious for not cooking stacked foods evenly. The stackable trays 34 shown in FIGS. 1-5 reduce or eliminate this problem. During the cooking process, some foods should not rest directly in the water inside the pressure cooking container assembly 10. Additionally, the trays 34 allow the benefit of cooking a three-course meal at a single time.

A method of pressure cooking using the pressure cooking container assembly 10 of the present invention is based upon combining software/recipes with the pressure cooking container assembly 10 in a microwave oven. As discussed above, the current practice in the food industry is to have someone who is cooking or warming food in a microwave punch holes in the bag or container, peel back film from the container, open a lid from the container or etc. and microwave for a range of time. This is due to the fact that different sized microwaves cook at different levels of power. By poking holes or cutting off corners, all steam is released from the cooking containers thus the prior art containers cannot be considered pressure cooking devices.

Seven factors are important when cooking in microwave ovens to produce accurate gourmet food fast, efficient and using considerably less energy than a stove or oven. The factors are as follows: 1) the type of food which is being cooked, 2) the weight of the food being cooked, 3) the vessel in which it is cooked, 4) the amount of liquid to be added, 5) the consistent pressure buildup with the cooking vessel, 6) the wattage of the microwave oven, and 7) the time to cook in that wattage of microwave oven. When these factors are identified by the user, consistent results in cooked food will follow.

Traditional pressure cookers allow fast and easy preparation of a wide variety of foods, preserve flavor and nutrition of foods, tenderizes lean cuts of meat, cooks food faster than ordinary cooking methods, and allows multiple foods to cook at the same time without the flavors intermingling. The microwavable pressure cooking container assembly 10 of the present invention has all of these benefits, plus can be used in a microwave oven for a much shorter cooking time. Problems with traditional pressure cookers are that they are subject to breakage requiring repairs and maintenance. The present invention is designed to be disposable after one or more uses. Traditional pressure cookers are potentially dangerous for building up large pressures. The pressure cooker of the present invention is contained within a microwave oven during the cooking process to reduce this danger. Many food items are restricted for use in traditional pressure cookers as they may block the vent or pressure pipes and plug the pressure release valve. Because of the design of the microwavable pressure cooking container assembly and the pressure valve 26 or aperture 28, there are no restrictions as to types of food which may be cooked in the present invention. Traditional pressure cookers also require oversight and judgment in cooking. The microwavable pressure cooking container assembly 10 of the present invention allows the user to simply set a cooking time on the microwave, start the microwave and leave the rest to the microwave. A user cannot realistically test food in a traditional pressure cooker to determine completion of cooking. Testing food is simple with the slider zipper 14 of the present invention.

The microwavable pressure cooking container assembly 10 is made of strong flexible film material rather than a rigid metal material of traditional pressure cookers. Additionally, the microwavable pressure cooking container assembly 10 of the present invention uses a microwave as the sole heat source for cooking whereas the traditional pressure cooker uses a stove as a heat source.

A brief explanation of heat transfer from a heat source to a cooking vessel and food is provided below. Conduction is the transfer of heat based upon the vessel containing the food where the food itself being in direct contact with the heat source, i.e., flame, electric heating element of a stove, grill, or etc. This is fast, direct heat transfer. Convection is the transfer of heat based upon heated air. An oven provides convection heat transfer, whereas a stovetop provides conduction heat transfer. Electromagnetic radiation is the heat created through the use of a microwave. Microwaves of electrical and magnetic energy move together through space to the product being cooked. Microwaves have three characteristics that allow them to be used in cooking: they are reflected by metal; they pass through glass, paper, plastic, and similar materials; and they are absorbed by foods. The microwavable pressure cooking container assembly and method of the present invention uses a combination of conduction, convection and electromagnetic radiation in cooking foods in a microwave oven. A key factor in the present invention is the containment of steam within the pressure cooking container assembly.

Traditional pressure cookers have a bobber and a vent pipe which retains about 30 pounds of pressure within the vessel. This is a combination of approximately 15 pounds of pressure in the vessel above atmospheric pressure of approximately 15 pounds of pressure. This value depends upon elevation and barometric pressure. Water generally boils at 212° F., unless super heated. Thus, the temperature of water cannot exceed a temperature of 212° F. at sea level as it converts to steam. On the other hand, when contained under pressure, steam can attain much higher temperatures. Consequently, when steam is contained in traditional pressure cookers and in the microwavable pressure cooking container assembly 10 of the present invention, the pressure increases, which in-turn increases the temperature of the steam. Contained steam and consequently, the level of pressure in the present invention is controlled by the size of the hole/aperture 28 or steam valve 26 used upon the pressure cooking container assembly 10. By adjusting or affecting the diameter of the opening or aperture 28, we can regulate the pressure and temperature of the steam so that there is no buildup of heat which would adversely affect the materials or film of which the flexible film vessel 12 is made.

Without water being added to the pressure cooking container assembly on food items requiring extended high temperature microwave cooking, i.e., chicken, pork chops, etc., the vessel 12 would attain temperatures well in excess of what the flexible film material could tolerate. Therefore, regulating the steam and consequently the temperature inside the microwavable pressure cooking container assembly 10 allows one to maintain steam under a pressure of a temperature of a few degrees above the boiling point of water; but not so restrictive as to raise the pressure and, consequently, the temperature to adversely affect the material of which the film vessel 12 is made or its integrity as a vessel 12.

Because of the containment of the steam inside the microwavable pressure cooking container assembly 10, millions of microscopic steam molecules are moving by convection to the food transferring their heat by conduction to the food. Because of the approximately 30 pounds of pressure in the container assembly 10, the steam molecules are being pushed against the food as forced conduction. In understanding that steam can attain additional or higher temperatures of heat under pressure above the general boiling temperature of water, the steam floats through the cooking container assembly 10 touching the entire surface of the food enabling the steam molecules to transfer their heat by conduction directly to the food with some amount of heat penetration into the food based upon pressure. Along with the benefit of speed and steam/pressure containment cooking, flavor, texture and nutrition are retained and enhanced in the microwavable pressure cooking container assembly 10 of the present invention.

In addition to the heat mentioned above, the microwave oven's major speed contribution is its source of heat, namely electromagnetic radiation. These waves of electrical and magnetic energy not only heat the water fast creating steam, but penetrate the food creating conduction heat transfer within the food. Therefore the microwave oven can cook food faster, using less energy than traditional pressure cookers because the heating effect is instantaneous and there is no heat transfer delay to the food by having to heat the vessel that the food is being cooked in. The benefit of cooking speed could be a catch-22 circumstance when microwaving fatty foods. Fatty foods will build up high temperatures within the vessels because of the contained conduction heat. Cooking quantities of fatty foods are insulated from damaging the flexible film vessel even though their temperatures reach high levels. Because these hot fatty foods are resting in boiling water, which helps to maintain a temperature and the food temperatures are insulated from the film when surrounded by the steam molecules floating in a convection manner. In other words, the film vessel 12 is insulated from the heat being emitted by the food.

The microwave oven generates 100 percent of its heat transfer almost instantly and there is no delay or warming period of time needed as in traditional cooking vessels. Thus, cooking begins immediately and the person cooking the food does not need to wait for the pressure in a traditional pressure cooker to build up before food really gets cooking. In addition, the microwave allows for the cook to be absent when desired cooking time has been reached. In other words, the cook does not need to be near the pressure cooker to turn off the heat or cool down the pressure cooker because microwaves stop at the desired time and the heating source is stopped as well.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

What is claimed is:

1. A microwavable pressure cooking container assembly comprising:
a flexible film vessel capable of holding a quantity of a liquid and food;
a sealing device at an upper portion of the vessel for sealing a portion of the vessel;
an aperture in an upper portion of the vessel which restricts release of steam from the vessel, so as to cause an increase in pressure and heat within the vessel to a level of pressure and heat which does not adversely affect the flexible film vessel, yet increases speed of cooking the food.

2. The microwavable pressure cooking container of claim 1 further comprising a gusseted bottom on the flexible film vessel.

3. The microwavable pressure cooking container of claim 1 wherein the flexible film vessel is constructed from retort plastic film.

4. The microwavable pressure cooking container of claim 1 wherein the sealing device is a zipper closer device.

5. The microwavable pressure cooking container of claim 1 wherein a lower portion of the flexible film vessel is pie shaped to allow multiple vessels to stand beside one another on a circular tray.

6. The microwavable pressure cooking container of claim 1 further comprising one or more tabs attached to the sides of the flexible film vessel for holding the vessel and for moving the sides of the flexible film vessel toward each other for assisting opening and closing the sealing device.

7. The microwavable pressure cooking container of claim 1 further comprising one or more steam resistant trays removeably located inside the vessel for holding food at different levels inside the vessel and allowing steam to pass through and/or around the one or more trays.

8. The microwavable pressure cooking container of claim 7 wherein the trays further comprise a plurality of legs for maintaining a distance from a bottom of the vessel and for maintaining a distance between the one or more trays.

9. The microwavable pressure cooking container of claim 1 wherein the aperture seals itself when there is low pressure inside the vessel and the aperture vents excess pressure to outside the vessel when pressure inside the vessel reaches a threshold pressure.

10. A method of cooking food in a microwave comprising:
placing the food in a microwaveable pressure cooking container, the container capable of restricting release of steam to maintain a desired pressure inside the container;
adding a liquid inside the container;
sealing a portion of the container;
placing the container in a microwave oven;
setting a time for cooking the food; and
starting the microwave oven, thereby allowing steam to build-up in the container and vent from the container at a pre-determined pressure.

11. The method of cooking food in a microwave of claim 10 further comprising cooling the food in the container after cooking and storing the container for later re-heating of the food in the container.

12. The method of cooking food in a microwave of claim 10 further comprising calculating an approximate mass for the food placed in the container.

13. The method of cooking food in a microwave of claim 10 further comprising adding spices to flavor the food.

14. The method of cooking food in a microwave of claim 10 further comprising spacing multiple foods apart from one another using one or more trays for holding the food.
